(19) United States
(12) Patent Application Publication
(10) Pub. No.: US 2021/0308996 A1
(43) Pub. Date: Oct. 7, 2021

(54) MULTILAYER FILM AND IMPLEMENTATIONS THEREOF

(71) Applicant: EPL LIMITED, Mumbai (IN)

(72) Inventor: Hariharan Krishnan Nair, Mumbai (IN)

(21) Appl. No.: 17/352,193

(22) Filed: Jun. 18, 2021

Related U.S. Application Data
(63) Continuation of application No. 17/282,737.

(30) Foreign Application Priority Data
Oct. 7, 2019 (IN) 201921040614

(51) Int. Cl. B32B 27/08; B32B 27/32; B32B 27/30; B32B 7/02; B32B 1/08; B32B 37/15; B29C 48/00; B29C 48/10; B29C 48/21; B65D 65/40

(52) U.S. Cl. CPC B32B 27/08; B29K 2023/086; B32B 27/306; B32B 7/02; B32B 1/08; B32B 37/153; B29C 48/0018; B29C 48/0021; B29C 48/022; B29C 48/10; B29C 48/21; B65D 65/40; B32B 2307/4026; B32B 2597/00; B32B 2307/54; B32B 2553/00; B29K 2023/06; B32B 27/32

(57) ABSTRACT

The present disclosure discloses a multilayer film comprising: (a) at least one print layer (102); (b) at least one tie layer (104); (c) at least one second tie layer (108); and (d) at least one sealant layer (110), wherein the multilayer film comprises at least one polyethylene having a weight percentage in the range of 80-95% with respect to the multilayer film, and a density in the range of 0.941-0.99 gm/cm³. Also disclosed herein is a process of manufacturing a multilayer film.

### CROSS-REFERENCE TO RELATED APPLICATIONS

This application is a continuation of U.S. application Ser. No. 17/282,737, filed on Apr. 2, 2021 as the U.S. National Phase under 35. U.S.C. § 371 of International Application PCT/IN2020/050862, filed Oct. 7, 2020, which claims priority to Indian Patent Application No. 201921040614, filed Oct. 7, 2019. The disclosures of the above-described applications are hereby incorporated by reference in their entirety.

### TECHNICAL FIELD OF THE INVENTION

The present invention relates to a multilayer film for packaging comprising four or more layers having attributes, such as, good stiffness, resilience, and bounce back. It also relates to a process of manufacturing such a multilayer film.

### BACKGROUND OF THE INVENTION

Packaging is an essential part of a product in today's developing world. And yet, with today's environmental concern, reducing waste and energy usage while increasing product sustainability has been the priority. A major challenge faced by packaging technology advancement relates to sustainable packaging. Innovation in sustainable packaging technologies can play a vital role in transforming the world. Sustainable packaging these days is just not limited to focusing on recycling, instead other parameters, such as reducing weight and volume of the packaging, eliminating or minimizing toxic additives, and reducing energy consumption are also equally important in deciding the sustainability of packaging materials, without affecting the functionalities and feel of the packaging material.

U.S. Pat. No. 8,709,595B2 discloses a food packaging article comprising a myoglobin blooming agent selected from nitrogen heterocycles, fremy's salts, nitrate and nitrite salts.

JP5743376B2 discloses a packaging web having a coextruded unstretched metallized sealant film. U.S. Pat. No. 7,029,734B1 discloses a multilayer packaging film for aseptic package applications, wherein the multilayer packaging film includes a sealant layer comprising an olefin polymer, an oxygen barrier layer and an outer layer comprising polyester homopolymers having silicone or other hydrogen peroxide resistant exterior coating. WO 2012/160436 discloses a polymer composition comprising: at least one low density polyethylene (LDPE); at least one linear low density polyethylene (LLDPE); and a nucleating agent in an amount in the range of 1.5% to 3.0% w/w of the total weight of the composition; wherein the low density polyethylene and the linear low density polyethylene are in a ratio in the range of 1:1 to 3:1 w/w.

Most of the currently used packaging films include components such as polyvinyl dichloride, metal complexes and salts, and other synthetic chemicals that are associated with several environmental health concerns. As sustainability takes a center stage, there is a dire need in the present state of the art for a suitable packaging material which fulfills the parameters to qualify under the category of sustainable packaging.

### SUMMARY OF THE INVENTION

In an aspect of the present disclosure, there is provided a multilayer film comprising: (a) at least one print layer (102); (b) at least one tie layer (104); (c) at least one second tie layer (108); and (d) at least one sealant layer (110), wherein the multilayer film comprises at least one polyethylene having a weight percentage in the range of 80-95% with respect to the multilayer film, and a density in the range of 0.941-0.99 gm/cm³.

In another aspect of the present disclosure, there is provided a process of manufacturing the multilayer film as described herein, the process comprising: (a) extrusion laminating the at least one barrier layer, the at least one sealant layer, and the at least one second tie layer to obtain a sheet; and (b) extrusion laminating the sheet, the at least one print layer, and the at least one tie layer to obtain the multilayer film.

These and other features, aspects and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a cross-section of a multilayer film (100), according to an implementation of the present disclosure.

FIG. 2 illustrates a cross-section of a multilayer film (200) comprising a barrier layer (106), according to an implementation of the present disclosure.

FIG. 3 illustrates a cross-section of a print layer (102) of a multilayer film (300), according to an implementation of the present disclosure.

FIG. 4 illustrates a cross-section of a sealant layer (110) of a multilayer film (400), according to an implementation of the present disclosure.

FIG. 5 illustrates a cross-section of a multilayer film (500), according to another implementation of the present disclosure.

### DETAILED DESCRIPTION

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively and any and all combinations of any or more of such steps or features.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. Throughout this specification, unless the context requires otherwise the word “comprise”, and variations, such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The phrase “at least one polyethylene” refers to any polyethylene selected from the group consisting of high density polyethylene, medium density polyethylene, low density polyethylene, linear low density polyethylene, and combinations thereof. The at least one polyethylene with the meaning of the present disclosure has a density in the range of 0.941-0.99 gm/cm³ and melt flow index (MFI) in a range of 0.4 to 7.0 g/10 minutes.

The term “high density polyethylene” used herein refers to a polyethylene having a density in the range of 0.941-0.970 gm/cm³.

The term “medium density polyethylene” used herein refers to a polyethylene having a density in the range of 0.926-0.941 gm/cm³.

The term “low density polyethylene” used herein refers to a polyethylene having a density in the range of 0.919-0.935 gm/cm³.

The term “linear low density polyethylene” used herein refers to a polyethylene having a density in the range of 0.919-0.925 gm/cm³.

The term “stiffness” used herein refers to the resistance of a material to deformation under an applied force.

The term “young's modulus” used herein refers to the property of a material that is calculated by measuring the ratio of stress to strain incurred in the material. Young's modulus gives a measure of the stiffness of the material or the ease with which it can be stretched or bent. Higher the value of the young's modulus, lesser is the extent to which a material can be stretched or elongated, higher is the stiffness. It is measured in terms of N/m² or Pascal (Pa).

The term “melt flow index” or “MFI” used refers to the grams of a polymer flowing per 10 minutes through a capillary tube. It is a measure of the ease of flowing of the polymer melt denoted in terms of g/10 min.

The term “density” used herein refers to the mass of polymer present per unit volume of the multilayer film. It is measured in terms of g/cm³.

The term “extrusion polyethylene” used herein refers to two polyethylene films extruded out together to form a tie layer.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a thickness range of about 50 μm to about 200 μm should be interpreted to include not only the explicitly recited limits of about 50 μm to about 200 μm, but also to include sub-ranges, such as 65 μm to 155 μm, 70 μm to 190 μm, and so forth, as well as individual amounts, including fractional amounts, within the specified ranges, such as 65.2 μm, 160.6 μm, and 191.3 μm, for example.

As discussed in the background section, shifting to packaging by multilayer films which are sustainable is the need of the hour. Considering the problems faced with conventionally used packaging films, the present disclosure provides a multilayer film comprising: (a) at least one print layer (102); (b) at least one tie layer (104); (c) at least one second tie layer (108); and (d) at least one sealant layer (110), wherein the multilayer film comprises at least one polyethylene having a weight percentage in the range of 80-95% with respect to the multilayer film, and a density in the range of 0.941-0.99 gm/cm³. It is the presence of at least one polyethylene having a density in the range of 0.941-0.99 gm/cm³ in a high weight percentage, i.e., in the range of 80-95% with respect to the multilayer film, which enables source reduction, i.e., reduction of film thickness without affecting the functionalities of the multilayer film, such as, stability, stiffness and bounce back properties. The present multilayer films, even with a reduced thickness to 220 pm, do not fail to exhibit an improved young's modulus and enhanced stiffness. Moreover, the higher percentage of polyethylene having a density in the range of 0.941-0.99 gm/cm³ makes them a sustainable alternative to substitute the presently used packaging materials.

In an embodiment of the present disclosure, there is provided a multilayer film comprising: (a) at least one print layer (102); (b) at least one tie layer (104); (c) at least one second tie layer (108); and (d) at least one sealant layer (110), wherein the multilayer film comprises at least one polyethylene having a weight percentage in the range of 80-95% with respect to the multilayer film, and a density in the range of 0.941-0.99 gm/cm³.

In another embodiment of the present disclosure, there is provided a multilayer film comprising: (a) at least one print layer comprising the at least one polyethylene; (b) at least one tie layer comprising the at least one polyethylene; (c) at least one second tie layer comprising the at least one polyethylene; and (d) at least one sealant layer comprising the at least one polyethylene, wherein the at least one polyethylene content is 80-95% with respect to the multilayer film, and the density of the at least one polyethylene is in the range of 0.941-0.99 gm/cm³.

In an embodiment of the present disclosure, there is provided a multilayer film as described herein, wherein the multilayer film comprises the at least one polyethylene having a density in the range of 0.945-0.99 gm/cm³.

In an embodiment of the present disclosure, there is provided a multilayer film as described herein, wherein the at least one polyethylene has a melt flow index in the range of 0.4 to 7.0 g/10 minutes.

In an embodiment of the present disclosure, there is provided a multilayer film as described herein, wherein the multilayer film has a thickness in the range of 170 μm-400 μm. In one another embodiment of the present disclosure, the multilayer film has a thickness of 220 μm. In yet another embodiment of the present disclosure, the multilayer film has a thickness of 250 pm. In one another embodiment of the present disclosure, the multilayer film has a thickness of 300 μm. In yet another embodiment of the present disclosure, the multilayer film has a thickness of 350 μm. In one another embodiment of the present disclosure, the multilayer film has a thickness of 390 μm.

In an embodiment of the present disclosure, there is provided a multilayer film as described herein, wherein the multilayer film further comprises at least one barrier layer (106) between the at least one tie layer (104) and the at least one second tie layer (108).

In an embodiment of the present disclosure, there is provided a multilayer film as described herein, wherein the at least one print layer (102) comprises: (a) a first layer (202) comprising the at least one polyethylene; (b) a second layer (204) comprising the at least one polyethylene; and (c) a third layer (206) comprising the at least one polyethylene, wherein the first layer to the second layer thickness ratio is in the range of 1:1 to 1:4, the first layer to the third layer thickness ratio is in the range of 1:1 to 1:2, the second layer is in contact with the first layer (202) and the third layer (206), the first layer is in contact with the at least one tie layer. In one another embodiment of the present disclosure, the first layer to the second layer thickness ratio is in the range of 1:1 to 1:3, the first layer to the third layer thickness ratio is in the range of 1:1 to 1:1.5. In yet another embodiment of the present disclosure, the first layer to the second layer thickness ratio is 1:2, the first layer to the third layer thickness ratio is 1:1.

In an embodiment of the present disclosure, there is provided a multilayer film as described herein, wherein the second layer (204) and the third layer (206) independently comprises at least one colorant master batch (MB).

In an embodiment of the present disclosure, there is provided a multilayer film as described herein, wherein the second layer (204) and the third layer (206) independently comprises at least one colorant master batch comprising at least one pigment selected from the group consisting of titanium dioxide (TiO₂), zinc sulphide (ZnS₂), zinc oxide (ZnO), barium sulfate (BaSO₄), and calcium carbonate (CaCO₃). In another embodiment of the present disclosure, the second layer (204) comprises a white colorant master batch made from titanium dioxide (TiO₂).

In an embodiment of the present disclosure, there is provided a multilayer film as described herein, wherein the at least one print layer (102) has a thickness in the range of 50 μm-200 μm. In one another embodiment of the present disclosure, the at least one print layer (102) has a thickness in the range of 100 μm-170 μm. In yet another embodiment of the present disclosure, the at least one print layer (102) has a thickness of 110 μm. In one another embodiment of the present disclosure, the at least one print layer (102) has a thickness of 140 μm. In yet another embodiment of the present disclosure, the at least one print layer (102) has a thickness of 150 μm.

In an embodiment of the present disclosure, there is provided a multilayer film as described herein, wherein the at least one tie layer (104) and the at least one second tie layer (108) independently has a thickness in the range of 15 μm-40 μm. In one another embodiment of the present disclosure, the at least one tie layer (104) and the at least one second tie layer (108) independently has a thickness in the range of 17 μm-30 μm. In yet another embodiment of the present disclosure, the at least one tie layer (104) and the at least one second tie layer (108) independently has a thickness in the range of 19 μm-25 μm. In one another embodiment of the present disclosure, the at least one tie layer (104) and the at least one second tie layer (108) independently has a thickness of 20 μm.

In an embodiment of the present disclosure, there is provided a multilayer film as described herein, wherein the at least one tie layer (104) and the at least one second tie layer (108) independently comprises the at least one polyethylene.

In an embodiment of the present disclosure, there is provided a multilayer film as described herein, wherein the at least one barrier layer (106) comprises 3-11 layers and has a thickness in the range of 50 μm-150 μm. In another embodiment of the present disclosure, the at least one barrier layer (106) comprises 4-7 layers and has a thickness in the range of 50 μm-70 μm. In yet another embodiment of the present disclosure, the at least one barrier layer (106) comprises 4-7 layers and has a thickness of 50 μm.

In an embodiment of the present disclosure, there is provided a multilayer film as described herein, wherein the at least one barrier layer (106) comprises EVOH having a weight percentage in the range of 1-10% with respect to the multilayer film.

In an embodiment of the present disclosure, there is provided a multilayer film as described herein, wherein the at least one sealant layer (110) comprises 1-3 layers and has a thickness in the range of 50 μm-150 μm. In another embodiment of the present disclosure, the at least one sealant layer (110) comprises 1-3 layers and has a thickness in the range of 60 μm-120 μm. In yet another embodiment of the present disclosure, the at least one sealant layer (110) comprises 1-3 layers and has a thickness of 50 μm. In one another embodiment of the present disclosure, the at least one sealant layer (110) comprises 1-3 layers and has a thickness of 70 μm. In yet another embodiment of the present disclosure, the at least one sealant layer (110) comprises 1-3 layers and has a thickness of 110 μm.

In an embodiment of the present disclosure, there is provided a multilayer film as described herein, wherein the at least one sealant layer (110) comprises the at least one polyethylene.

In an embodiment of the present disclosure, there is provided a multilayer film as described herein, wherein the at least one sealant layer (110) comprises: (a) a primary layer (302) comprising the at least one polyethylene; (b) a secondary layer (304) comprising the at least one polyethylene; and (c) a tertiary layer (306) comprising the at least one polyethylene, wherein the primary layer (302) to the secondary layer (304) thickness ratio is in the range of 1:1 to 1:4, the primary layer (302) to the tertiary layer (306) thickness ratio is in the range of 1:1 to 1:2, the secondary layer (304) is in contact with the primary layer (302) and the tertiary layer (306), the primary layer (302) is in contact with the at least one second tie layer (108). In another embodiment of the present disclosure the primary layer (302) to the secondary layer (304) thickness ratio is in the range of 1:1 to 1:3, the primary layer (302) to the tertiary layer (306) thickness ratio is in the range of 1:1 to 1:1.5. In yet another embodiment of the present disclosure the primary layer (302) to the secondary layer (304) thickness ratio is 1:2, the primary layer (302) to the tertiary layer (306) thickness ratio is 1:1.

In an embodiment of the present disclosure, there is provided a multilayer film comprising: (a) at least one print layer (102) comprising: (1) a first layer (202) comprising the at least one polyethylene; (2) a second layer (204) comprising the at least one polyethylene; and (3) a third layer (206) comprising the at least one polyethylene, wherein the second layer (204) is in contact with the first layer (202) and the third layer (206), the first layer (202) is in contact with the at least one tie layer (104); (b) at least one tie layer (104) comprising the at least one polyethylene; (c) at least one second tie layer (108) comprising the at least one polyethylene; and (d) at least one sealant layer (110) comprising: (i) a primary layer (302) comprising the at least one polyethylene; (ii) a secondary layer (304) comprising the at least one polyethylene; and (iii) a tertiary layer (306) comprising the at least one polyethylene, wherein the secondary layer (304) is in contact with the primary layer (302) and the tertiary layer (306), the primary layer (302) is in contact with the at least one second tie layer (108), wherein the at least one polyethylene content is 80-95% with respect to the multilayer film, and the density of the at least one polyethylene is in the range of 0.941-0.99 gm/cm³.

In an embodiment of the present disclosure, there is provided a multilayer film comprising: (a) at least one print layer (102) comprising the at least one polyethylene; (b) at least one tie layer (104) comprising the at least one polyethylene; (c) at least one second tie layer (108) comprising the at least one polyethylene; (d) at least one sealant layer (110) comprising the at least one polyethylene; and (e) a barrier layer (106) between the at least one tie layer (104) and the at least one second tie layer (108), wherein the at least one polyethylene content is 80-95% with respect to the multilayer film, and the density of the at least one polyethylene is in the range of 0.941-0.99 gm/cm³.

In an embodiment of the present disclosure, there is provided a multilayer film comprising: (a) at least one print layer (102) comprising: (1) a first layer (202) comprising a combination of HDPE and MDPE; (2) a second layer (204) comprising a combination of HDPE and MDPE; and (3) a third layer (206) comprising a combination of HDPE and MDPE, wherein the second layer (204) is in contact with the first layer (202) and the third layer (206), the first layer (202) is in contact with the at least one tie layer (104); (b) at least one tie layer (104) comprising LDPE; (c) at least one second tie layer (108) comprising LDPE; (d) at least one sealant layer (110) comprising: (i) a primary layer (302) comprising a combination of HDPE and MDPE; (ii) a secondary layer (304) comprising a combination of HDPE and MDPE; and (iii) a tertiary layer (306) comprising a combination of HDPE and MDPE, wherein the primary layer (302) to the secondary layer (304) thickness ratio is 1:2, the primary layer (302) to the tertiary layer (306) thickness ratio is 1:1, the secondary layer (304) is in contact with the primary layer (302) and the tertiary layer (306), the primary layer (302) is in contact with the at least one second tie layer (108); and (e) a barrier layer (106) between the at least one tie layer (104) and the at least one second tie layer (108) comprising: (1) a first barrier layer comprising a combination of HDPE and MDPE; (2) an outer tie layer comprising maleic anhydride grafted LLDPE; (3) an EVOH barrier layer; (4) an inner tie layer comprising maleic anhydride grafted LLDPE; and (5) a second barrier layer comprising a combination of HDPE and MDPE, wherein the at least one polyethylene content is 80-95% with respect to the multilayer film, and the density of the at least one polyethylene is in the range of 0.941-0.99 gm/cm³.

In an embodiment of the present disclosure, there is provided a multilayer film having a thickness in the range of 170 μm-400 μm comprising: (a) at least one print layer (102) having a thickness in the range of 50 μm-200 μm comprising: (1) a first layer (202) comprising the at least one polyethylene; (2) a second layer (204) comprising the at least one polyethylene and optionally comprising a colorant master batch; and (3) a third layer (206) comprising the at least one polyethylene, wherein the first layer to the second layer thickness ratio is in the range of 1:1 to 1:4, the first layer to the third layer thickness ratio is in the range of 1:1 to 1:2, the second layer is in contact with the first layer (202) and the third layer (206), the first layer is in contact with the at least one tie layer; (b) at least one tie layer (104) having a thickness in the range of 15 μm-40 μm comprising the at least one polyethylene; (c) at least one second tie layer (108) having a thickness in the range of 15 μm-40 μm comprising the at least one polyethylene; (d) at least one sealant layer (110) having a thickness in the range of 50 μm-150 μm comprises 1-3 layers comprising: (i) a primary layer (302) comprising the at least one polyethylene; (ii) a secondary layer (304) comprising the at least one polyethylene; (iii) a tertiary layer (306) comprising the at least one polyethylene, wherein the primary layer (302) to the secondary layer (304) thickness ratio is in the range of 1:1 to 1:4, the primary layer (302) to the tertiary layer (306) thickness ratio is in the range of 1:1 to 1:2, the secondary layer (304) is in contact with the primary layer (302) and the tertiary layer (306), the primary layer (302) is in contact with the at least one second tie layer (108); and (e) a barrier layer (106) between the at least one tie layer (104) and the at least one second tie layer (108) having a thickness in the range of 50 μm-150 μm comprises 3-11 layers comprising EVOH having a weight percentage in the range of 1-10% with respect to the multilayer film, wherein the at least one polyethylene content is 80-95% with respect to the multilayer film, and the density of the at least one polyethylene is in the range of 0.941-0.99 gm/cm³.

In an embodiment of the present disclosure, there is provided a multilayer film having a total thickness of 250 μm comprising: (a) at least one print layer (102) comprising 3-layers having a total thickness of 110 μm, wherein the at least one print layer comprises: (1) a first layer (202) comprising a combination of HDPE and MDPE; (2) a second layer (204) comprising a combination of HDPE, MDPE, and 10% white colorant master batch; and (3) a third layer (206) comprising a combination of HDPE and MDPE, wherein the second layer (204) is in contact with the first layer (202) and the third layer (206), the first layer (202) is in contact with the at least one tie layer (104); (b) at least one tie layer (104) comprising LDPE having a total thickness of 20 μm; (c) at least one second tie layer (108) comprising LDPE having a total thickness of 20 μm; (d) at least one sealant layer (110) comprising 3-layers having a total thickness of 50 μm, wherein the at least one sealant layer comprises: (i) a primary layer (302) comprising a combination of HDPE and MDPE; (ii) a secondary layer (304) comprising a combination of HDPE and MDPE; and (iii) a tertiary layer (306) comprising a combination of HDPE and MDPE, wherein the primary layer (302) to the secondary layer (304) thickness ratio is 1:2, the primary layer (302) to the tertiary layer (306) thickness ratio is 1:1, the secondary layer (304) is in contact with the primary layer (302) and the tertiary layer (306), the primary layer (302) is in contact with the at least one second tie layer (108); and (e) a barrier layer (106) between the at least one tie layer (104) and the at least one second tie layer (108) comprising 5-layers having a total thickness of 50 μm, wherein barrier layer comprises: (1) a first barrier layer comprising a combination of HDPE and MDPE having a total thickness of 10 μm; (2) an outer tie layer comprising maleic anhydride grafted LLDPE having a total thickness of 7.5 μm; (3) an EVOH barrier layer having a thickness of 15 μm; (4) an inner tie layer comprising maleic anhydride grafted LLDPE having a total thickness of 7.5 μm; and (5) a second barrier layer comprising a combination of HDPE and MDPE having a total thickness of 10 μm, wherein the at least one polyethylene content is 80-95% with respect to the multilayer film, and the density of the at least one polyethylene is in the range of 0.941-0.99 gm/cm³.

In an embodiment of the present disclosure, there is provided a multilayer film having a total thickness of 300 μm comprising: (a) at least one print layer (102) comprising 3-layers having a total thickness of 140 μm, wherein the at least one print layer comprises: (1) a first layer (202) comprising a combination of HDPE and MDPE; (2) a second layer (204) comprising a combination of HDPE, MDPE, and 10% white colorant master batch; and (3) a third layer (206) comprising a combination of HDPE and MDPE, wherein the second layer (204) is in contact with the first layer (202) and the third layer (206), the first layer (202) is in contact with the at least one tie layer (104); (b) at least one tie layer (104) comprising LDPE having a total thickness of 20 μm; (c) at least one second tie layer (108) comprising LDPE having a total thickness of 20 μm; (d) at least one sealant layer (110) comprising 3-layers having a total thickness of 70 μm, wherein the at least one sealant layer comprises: (i) a primary layer (302) comprising a combination of HDPE and MDPE; (ii) a secondary layer (304) comprising a combination of HDPE and MDPE; and (iii) a tertiary layer (306) comprising a combination of HDPE and MDPE, wherein the primary layer (302) to the secondary layer (304) thickness ratio is 1:2, the primary layer (302) to the tertiary layer (306) thickness ratio is 1:1, the secondary layer (304) is in contact with the primary layer (302) and the tertiary layer (306), the primary layer (302) is in contact with the at least one second tie layer (108); and (e) a barrier layer (106) between the at least one tie layer (104) and the at least one second tie layer (108) comprising 5-layers having a total thickness of 50 μm, wherein barrier layer comprises: (1) a first barrier layer comprising a combination of HDPE and MDPE having a total thickness of 10 μm; (2) an outer tie layer comprising maleic anhydride grafted LLDPE having a total thickness of 7.5 μm; (3) an EVOH barrier layer having a thickness of 15 μm; (4) an inner tie layer comprising maleic anhydride grafted LLDPE having a total thickness of 7.5 μm; and (5) a second barrier layer comprising a combination of HDPE and MDPE having a total thickness of 10 μm, wherein the at least one polyethylene content is 80-95% with respect to the multilayer film, and the density of the at least one polyethylene is in the range of 0.941-0.99 gm/cm³.

In an embodiment of the present disclosure, there is provided a multilayer film having a total thickness of 350 μm comprising: (a) at least one print layer (102) comprising 3-layers having a total thickness of 150 μm, wherein the at least one print layer comprises: (1) a first layer (202) comprising a combination of HDPE and MDPE; (2) a second layer (204) comprising a combination of HDPE, MDPE, and 10% white colorant master batch; and (3) a third layer (206) comprising a combination of HDPE and MDPE, wherein the second layer (204) is in contact with the first layer (202) and the third layer (206), the first layer (202) is in contact with the at least one tie layer (104); (b) at least one tie layer (104) comprising LDPE having a total thickness of 20 μm; (c) at least one second tie layer (108) comprising LDPE having a total thickness of 20 μm; (d) at least one sealant layer (110) comprising 3-layers having a total thickness of 110 μm, wherein the at least one sealant layer comprises: (i) a primary layer (302) comprising a combination of HDPE and MDPE; (ii) a secondary layer (304) comprising a combination of HDPE and MDPE; and (iii) a tertiary layer (306) comprising a combination of HDPE and MDPE, wherein the primary layer (302) to the secondary layer (304) thickness ratio is 1:2, the primary layer (302) to the tertiary layer (306) thickness ratio is 1:1, the secondary layer (304) is in contact with the primary layer (302) and the tertiary layer (306), the primary layer (302) is in contact with the at least one second tie layer (108); and (e) a barrier layer (106) between the at least one tie layer (104) and the at least one second tie layer (108) comprising 5-layers having a total thickness of 50 μm, wherein barrier layer comprises: (1) a first barrier layer comprising a combination of HDPE and MDPE having a total thickness of 10 μm; (2) an outer tie layer comprising maleic anhydride grafted LLDPE having a total thickness of 7.5 μm; (3) an EVOH barrier layer having a thickness of 15 μm; (4) an inner tie layer comprising maleic anhydride grafted LLDPE having a total thickness of 7.5 μm; and (5) a second barrier layer comprising a combination of HDPE and MDPE having a total thickness of 10 μm, wherein the at least one polyethylene content is 80-95% with respect to the multilayer film, and the density of the at least one polyethylene is in the range of 0.941-0.99 gm/cm³.

In an embodiment of the present disclosure, there is provided a process of manufacturing the multilayer film as described herein, the process comprising: (a) extrusion laminating the at least one barrier layer, the at least one sealant layer, and the at least one second tie layer to obtain a sheet; and (b) extrusion laminating the sheet, the at least one print layer, and the at least one tie layer to obtain the multilayer film.

In another embodiment of the present disclosure, there is provided an alternate process of manufacturing multilayer film wherein polymers such as medium density polyethylene (MDPE), high density polyethylene (HDPE), low density polyethylene (LDPE), linear low density polyethyelene with appropriate MFI (melt flow index), density and ratio are run through 3 layers blown or cast film making process. Layer ratio of the three layers film range between 1:1:1 to 1:4:1. Both outer print film and sealant film have been made in this process. Thicknesses of these films are kept between 50 and 150 premade multilayer outer film is mounted on the main un-winder of the laminating machine. Through various idle rollers, film reaches to the first lamination head and to NIP junction (combination of chill roll and rubberized nip roll), at least one tie layer as bond or tie between print layer and the barrier layer, with the rubberized nip pressure of 20 to 40 pound per linear inch, co-extruded hot polymer melt spread uniformly and help uniform bond strength between print layer and the barrier layer. By exchanging heat with the chill roll, three-layer film gets cool down to ambient temperature, Similarly, the sealant with the at least one second tie layer is extrusion laminated with the barrier layer. Polymer composition for tie layer or the second tie layer is extrusion low density polyethylene. With the nip pressure, all the sub assembled layers, get bonded, by exchanging heat with the chill roll, composite multilayer film gets cool down to ambient temperature, composite multilayer film thus made is cured at ambient temperature for 72 hours before secondary operation such as slitting, printing and tubing.

### Abbreviations

MD: machine direction;
TD: Transverse direction;
MPa denotes mega-pascal;
μm denotes micrometer;
mg denotes milligram

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may apply.

### Example 1

### Process for Preparing a Multilayer Film

The multilayer film of the present disclosure is prepared by blown film extrusion, wherein all the layers are prepared by blown film extrusion and then are extrusion laminated to form the multilayer film. The process for preparing a multilayer film of the present disclosure comprises extrusion laminating the at least one barrier layer, the at least one sealant layer, and the at least one second tie layer to obtain a sheet; and extrusion laminating the sheet, the at least one print layer and the at least one tie layer to obtain the multilayer film.

### Example 2

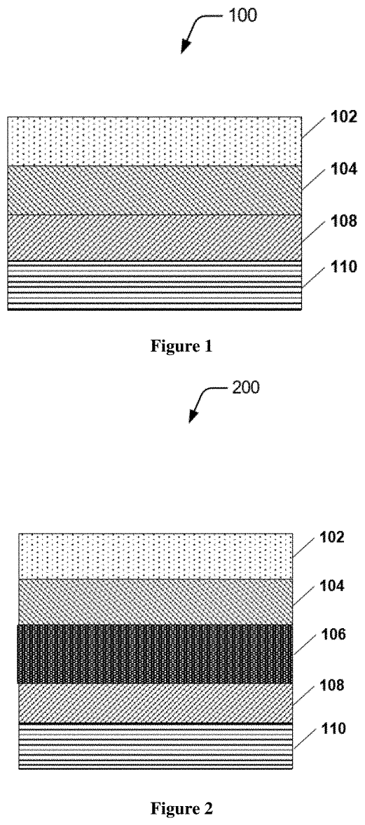

In an example, the multilayer film is as represented in the FIG. 1. The cross-section of the multilayer film 100 from outside to inside comprises at least one print layer (102), at least one tie layer (104), at least one second tie layer (108), and at least one sealant layer (110). The multilayer film of the FIG. 1 comprises at least one polyethylene having a weight percentage in the range of 80-95% with respect to the multilayer film, and a density in the range of 0.941-0.99 gm/cm³. In an example, the thickness of the at least one print layer (102) is 150 μm. In another example the at least one print layer comprises at least one colorant master batch. In an example, the at least one tie layer has a thickness 30 μm. In an example, the at least one tie layer (104) is made up of extrusion polyethylene. In an example, the at least one second tie layer (108) is same or different from the at least one tie layer. In an example, the at least one second tie layer has a thickness 30 μm. In an example the at least one sealant layer (110) comprises at least one polyethylene and has a thickness 84 μm.

### Example 3

FIG. 2 differs from the FIG. 1 only in that the multilayer film (200) further comprises at least one barrier layer (106). In an example, the multilayer film comprising a barrier layer (200) is represented in the FIG. 2. The multilayer film of the Example 1 further comprises at least one barrier layer (106) to form the multilayer film of FIG. 2. The at least one barrier layer (106) is present between the at least one tie layer (104) and the at least one second tie layer (108). In an example, the at least one barrier layer is a 3-layer structure and has a thickness in the range of 50-150 μm. In another example, the at least one barrier layer is a 5-layer structure and has a thickness in the range of 50-150 μm. In one another example, the at least one barrier layer is a 7-layer structure and has a thickness in the range of 50-150 μm. In yet another example, the at least one barrier layer is a 9-layer structure and has a thickness in the range of 50-150 μm. In one another example, the at least one barrier layer is a 11-layer structure and has a thickness in the range of 50-150 μm.

In another example, the at least one barrier layer is an EVOH barrier layer having a thickness of 125 μm. In yet another example, the at least one barrier layer is a 7-layer EVOH barrier layer with layers from outer to inner side are layer 1, layer 2, layer 3, layer 4, layer 5, layer 6, and layer 7. The layer 1 of the barrier layer is in contact with the at least one tie layer (104), and the layer 7 is in contact with the at least second tie layer (108).

### Example 4

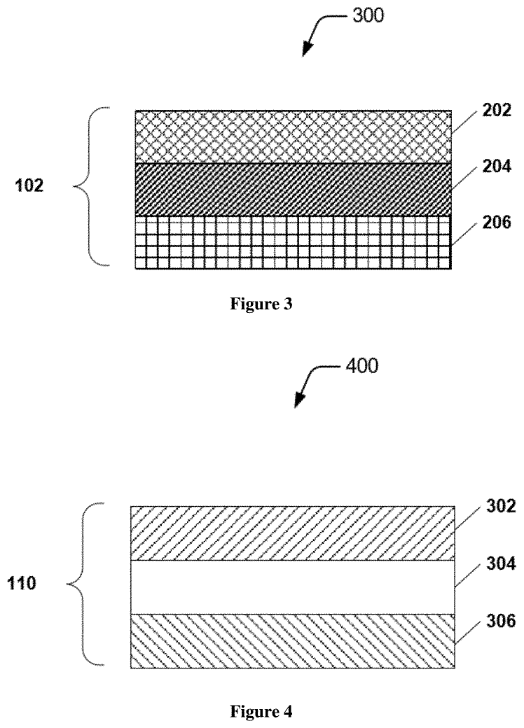

In an example the at least one print layer (102) is illustrated in FIG. 3 (300). The at least one print layer is a 3-layer structure. The at least one print layer comprises a first layer (202) having a thickness of 30 μm, a second layer (204) having a thickness of 90 μm, a third layer (206) having a thickness of 30 μm. The second layer (204) may optionally comprise at least one colorant master batch. The weight percentage of the colorant master batch in the second layer may be in the range of 1-10% with respect to the at least one print layer. In an example, the third layer (206) may optionally comprise at least one colorant master batch. The weight percentage of the colorant master batch in the third layer may be in the range of 1-10% with respect to the at least one print layer. The first layer, second layer, and third layer comprise the at least one polyethylene having a density in the range of 0.941-0.99 gm/cm³. In another example, the first layer (202) is in contact with the at least one tie layer comprising the at least one polyethylene. The at least one print layer is prepared by blown film extrusion.

### Example 5

In an example the at least one sealant layer (110) is illustrated in FIG. 4 (400). The at least one sealant layer is a 3-layer structure. The at least one sealant layer comprises a primary layer (302) having a thickness of 30 μm, a secondary layer (304) having a thickness of 90 μm, a tertiary layer (306) having a thickness of 30 μm. The primary layer, secondary layer, and the tertiary layer comprise the at least one polyethylene having a density in the range of 0.941-0.99 gm/cm³. In an example, the primary layer (302) is in contact with the at least one second tie layer (108) comprising the at least one polyethylene. The at least one sealant layer is prepared by blown film extrusion.

### Example 6

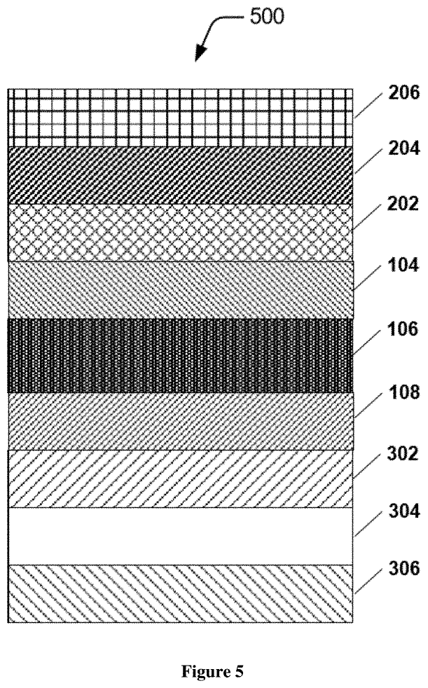

FIG. 5 illustrates a cross-section of a multilayer film (500). The multilayer film as illustrated in the FIG. 5 discloses a layered structure from outside to inside comprising at least one print layer, at least one tie layer, at least one barrier layer, at least one second tie layer, and at least one sealant layer. Multilayer films having thickness of 250 μm, 300 μm, and 350 μm were prepared.

In an example, the multilayer film having thickness of 250 μm comprises a print layer, wherein the print layer is a 3-layer structure. The print layer comprises a first layer comprising 30% HDPE and 70% MDPE, a second layer comprising 60% HDPE and 30% MDPE, and a third layer comprising 30% HDPE and 70% MDPE. The second layer also comprises colorant master batch. The weight percentage of the colorant master batch in the second layer is 10% with respect to the at least one print layer. The ratio of thickness of the first layer, second layer and third layer is 1:2:1 and the total thickness of the print layer is 110 μm. The first layer is in contact with the 20 μm thick tie layer comprising 100% LDPE by extrusion lamination. The multilayer layer film further comprises a 3-layer structure sealant layer. The sealant layer comprises a primary layer (302) comprising 30% HDPE and 70% MDPE, a secondary layer (304) comprising 70% HDPE and 30% MDPE, and a tertiary layer (306) comprising 30% HDPE and 70% MDPE. The ratio of thickness of the primary layer, secondary layer, and tertiary layer is 1:2:1 and the total thickness of the sealant layer is 50 μm. The primary layer is in contact with the 20 μm thick second tie layer comprising 100% LDPE by extrusion lamination. The multilayer film further comprises a barrier layer between the tie layer and the second tie layer. The barrier layer is a 5-layer EVOH barrier layer which comprises a 10 μm thick first barrier layer comprising 30% HDPE and 70% MDPE, a 7.5 μm thick outer and inner tie layer made from maleic anhydride grafted LLDPE, a 15 μm thick EVOH barrier layer, and a 10 μm thick second barrier layer comprising 30% HDPE and 70% MDPE, wherein the outer tie layer is positioned between the first barrier layer and the EVOH layer and the inner tie layer is positioned between the second barrier layer and the EVOH barrier layer. The first barrier layer is in contact with the tie layer and the second barrier layer is in contact with the second tie layer.

In further examples, multilayer film having thickness 300 μm and 350 μm were prepared, having the same structure as described above, but with varied thickness of the print layer and the sealant layer. In the multilayer film having thickness 300 μm, the print layer had a thickness of 140 μm and the sealant layer had a thickness of 70 μm. In the multilayer film having thickness 350 μm, the print layer had a thickness of 150 μm and the sealant layer had a thickness of 110 μm. Similar to above, multilayer films having thickness 220 μm and 390 μm were prepared.

### Example 8

### Mechanical Properties

The multilayer film of the present disclosure was used to make lamitubes having length 115 mm. Mechanical properties of the prepared lamitubes including stiffness and young's modulus were tested and the obtained results are recorded in the Table 1 below.

The multilayer films of thickness 220 μm, 250 μm, 350 μm and 350 μm were used to make lamitube samples 1, 2, 3, and 4 respectively. A 350 μm thick comparative film was also prepared having the below given structure. The stiffness test was conducted by following the standard procedure (TAPPI T556 standard method). The young's modulus and stiffness results are elaborated in Table 1 below. MD denotes machine direction and TD denotes transverse direction. MB (10%) denotes titanium dioxide master batch.

### Structure of the Comparative Film:

Top layer (3-layer film); Thickness: 150 μm;

### Layer 1 [LLDPE (100%)]; 30 μm

### Layer 2 [LDPE (70%)+LLDPE (15%)+MB (15%)]; 90 μm

### Layer 3 [LLDPE (100%)]; 30 μm

First adhesive layer; Thickness: 30 μm;

### [HDPE (0%)+LDPE (100%)]; 30 μm

Heat sealable blocking layer; Thickness: 55 μm;

### Layer 1 [LLDPE (100%)]

Layer 2 [LLDPE based tie layer]

### Layer 3 [EVOH]

### Layer 4 [EVOH]

Layer 5 [EVOH or tie layer]
Layer 6 [LLDPE based tie layer]

### Layer 7 [LLDPE (100%)]

Second adhesive layer; Thickness: 30 μm;

### [HDPE (0%)+LDPE (100%)]; 30 μm

Sealant layer (3-layer film); Thickness: 85 μm;

### Layer 1 [LLDPE (100%)]; 17 μm

### Layer 2 [LDPE (75%)+LLDPE (15%)+MB (15%)]; 51 μm

### Layer 3 [LLDPE (100%)]; 17 μm

TABLE 1

| | Thickness | | | Young's Modulus | |
|---|---|---|---|---|---|
| S.No. | (μm) | Stiffness (mg) | | (MPa) | |
| Samples | | MD | TD | MD | TD |
| 1 | 220 | 254 | 270 | 725 | 770 |
| 2 | 250 | 369 | 407 | 824 | 830 |
| 3 | 350 | 781 | 860 | 679 | 717 |
| 4 | 390 | 944 | 950 | 697 | 711 |
| Comparative film 5 | 350 | 612 | 700 | 499 | 535 |

It is clear from the Table 1 that the resin selection and orientation method are the primary variables that influence tensile values and thereby the stiffness of the multilayer film.

Young's modulus is synonymous with tensile modulus, a material property defined as the stress-strain ratio of the initial portion of a load extension curve. For instance, on comparison of the similar thickness samples, i.e, the sample 3 of the present disclosure in Table 1 showed much higher stiffness and young's modulus in comparison to the comparative film having the same thickness. A higher modulus value suggested that the multilayer films of the present disclosure are stiffer and have more resistance to elongation in use. Moreover, the data showed that despite the thickness being on lower sides, i.e., within the range of 220-390 μm, the property of stiffness was not compromised.

### ADVANTAGES OF THE PRESENT DISCLOSURE

The above-mentioned implementation examples as described on this subject matter and its equivalent thereof have many advantages, including those which are described.

The multilayer film of the present disclosure comprising four or more layers provides advantageous attributes, such as, good stiffness, resilience, and bounce back. The presence of at least one polyethylene having a density in the range of 0.941-0.99 gm/cm³ in a high weight percentage with respect to the multilayer film, i.e., in the range of 80-95%, enables source reduction, i.e., reduction of film thickness without affecting the functionalities of the multilayer film such as, stability, stiffness, etc. The stiffness of the multilayer film of the present disclosure with thickness in the range of 170 μm-400 μm was higher by almost 15-30% as compared to the commercial multilayer film of the same thickness. The design of the multilayer film enhances economic value compared to commercial films and helps in achieving greater sustainability in terms of multilayer film design with lesser film thickness yet higher stiffness and bounce back.

Although the subject matter has been described in considerable detail with reference to certain examples and implementations thereof, other implementations are possible. As such, the spirit and scope of the appended claims should not be limited to the description of the preferred examples and implementations contained therein.

I/We claim:

1. A multilayer film comprising:
(a) at least one print layer;
(b) at least one tie layer;
(c) at least one second tie layer; and
(d) at least one sealant layer,
wherein the multilayer film comprises at least one polyethylene having a weight percentage in the range of 80-95% with respect to the multilayer film, and a density in the range of 0.941-0.99 gm/cm3.

2. The multilayer film as claimed in claim 1, wherein the at least one polyethylene has a density is in the range of 0.945-0.99 gm/cm3.

3. The multilayer film as claimed in claim 1, wherein the at least one polyethylene has a melt flow index in the range of 0.4 to 7.0 g/10 minutes.

4. The multilayer film as claimed in claim 1, wherein the multilayer film has a thickness in the range of 170 μm-400 μm.

5. The multilayer film as claimed in claim 1, further comprises at least one barrier layer between the at least one tie layer and the at least one second tie layer.

6. The multilayer film as claimed in claim 1, wherein the at least one print layer comprises:
(a) a first layer comprising the at least one polyethylene;
(b) a second layer comprising the at least one polyethylene; and
(c) a third layer comprising the at least one polyethylene,
wherein the first layer to the second layer thickness ratio is in the range of 1:1 to 1:4, the first layer to the third layer thickness ratio is in the range of 1:1 to 1:2, the second layer is in contact with the first layer and the third layer, the first layer is in contact with the at least one tie layer.

7. The multilayer film as claimed in claim 6, wherein the second layer and the third layer independently comprises at least one colorant master batch.

8. The multilayer film as claimed in claim 1, wherein the at least one print layer has a thickness in the range of 50 μm-200 μm.

9. The multilayer film as claimed in claim 1, wherein the at least one tie layer and the at least one second tie layer independently has a thickness in the range of 15 μm-40 μm.

10. The multilayer film as claimed in claim 9, wherein the at least one tie layer and the at least one second tie layer independently comprises the at least one polyethylene.

11. The multilayer film as claimed in claim 5, wherein the at least one barrier layer comprises 3-11 layers and has a thickness in the range of 50 μm-150 μm.

12. The multilayer film as claimed in claim 5, wherein the at least one barrier layer comprises EVOH having a weight percentage in the range of 1-10% with respect to the multilayer film.

13. The multilayer film as claimed in claim 1, wherein the at least one sealant layer comprises 1-3 layers and has a thickness in the range of 50 μm-150 μm.

14. The multilayer film as claimed in claim 13, wherein the at least one sealant layer comprises the at least one polyethylene.

15. The multilayer film as claimed in claim 13, wherein the at least one sealant layer comprises:
(a) a primary layer comprising the at least one polyethylene;
(b) a secondary layer comprising the at least one polyethylene; and
(c) a tertiary layer comprising the at least one polyethylene,
wherein the primary layer to the secondary layer thickness ratio is in the range of 1:1 to 1:4, the primary layer to the tertiary layer thickness ratio is in the range of 1:1 to 1:2, the secondary layer is in contact with the primary layer and the tertiary layer, the primary layer is in contact with the at least one second tie layer.

16. The multilayer film as claimed in claim 7, wherein the at least one colorant master batch comprises at least one pigment selected from the group consisting of titanium dioxide (TiO2), zinc sulphide (ZnS2), zinc oxide (ZnO), barium sulfate (BaSO4), and calcium carbonate (CaCO3).

17. A process of manufacturing the multilayer film as claimed in claim 1, the process comprising:
(a) extrusion laminating the at least one barrier layer, the at least one sealant layer, and the at least one second tie layer to obtain a sheet; and
(b) extrusion laminating the sheet, the at least one print layer, and the at least one tie layer to obtain the multilayer film.
